(19) United States
(12) Patent Application Publication
(10) Pub. No.: US 2008/0087722 A1
(43) Pub. Date: Apr. 17, 2008

(54) System and method for permitting otherwise suspect credit card transactions

(75) Inventor: Kenneth A. Collins, Mission Viejo, CA (US)

Correspondence Address: ROGITZ & ASSOCIATES, 750 B STREET, SUITE 3120, SAN DIEGO, CA, 92101, US

(73) Assignee: John L. Rogitz

(21) Appl. No.: 11/546,816

(22) Filed: Oct. 11, 2006

(51) Int. Cl. G06K 5/00; G06Q 40/00

(52) U.S. Cl. 235/380; 705/44

(57) ABSTRACT

Instead of immediately turning down a suspect credit card transaction, when a merchant store connects to a credit card issuer computer and the issuer computer realizes that the limit will be exceeded or that the transaction is otherwise suspect, it sends a voice or text phone message to the card holder summarizing the attempted transaction and asking the card holder to input a code if the card holder approves. If the card holder replies with the right code within a predetermined period the transaction is approved; otherwise, it is not.

### FIELD OF THE INVENTION

The present invention is related to systems and methods for permitting legitimate credit card transactions that might appear to be suspect.

### BACKGROUND OF THE INVENTION

When attempting to pay for a purchase by credit card, some purchases that appear unusual to credit companies are often denied because certain factors of the purchase appear irregular to the credit company who issued the card. One example of a credit irregularity that concerns credit companies would be an instance where a purchaser attempts to charge his/her credit card account at a location inconsistent with the normal vicinity of the card's use (e.g., an American person's credit card being charged at a retail store in France). When certain transactions appear suspect to the credit company, the purchase is often automatically denied. These conservative safeguards attempt limit the liability of credit companies who are trying to minimize the occurrence of fraud, but it also creates barriers and inconvenience to its clients who are trying to make legitimate purchases. Moreover, credit card transactions are often denied because the current purchase would cause the balance on the individual's account to exceed their maximum predetermined balance. These circumstances can create unintended and embarrassing moments for credit card holders who are denied from completing a given transaction. Denial of purchases taking place in retail stores and other public forums is often seen as a negative indication of a person's financial and economic standing, among other things. The present invention minimizes these embarrassing and inconvenient moments.

### SUMMARY OF THE INVENTION

Instead of immediately turning down a suspect credit card transaction, when a merchant store connects to a credit card issuer computer and the issuer computer realizes that the limit will be exceeded or that the transaction is otherwise suspect, it sends a voice or text phone message to the card holder summarizing the attempted transaction and asking the card holder to input a code if the card holder approves. If the card holder replies with the right code within a predetermined period the transaction is approved; otherwise, it is not.

Accordingly, in one aspect a method for permitting credit card transactions includes receiving a credit card transaction request. If the transaction request is suspect, the method transmits to a telephone of a card holder of the credit card a message to input a code to indicate approval of the transaction. If the code is input, the method determines if it matches a predetermined code, and if the code is not input or if it is input but fails to match the predetermined code, the transaction is denied. Otherwise, the transaction is permitted.

The transaction may be considered to be suspect by virtue of exceeding a predetermined credit limit, and/or by virtue of a location of an attempted transaction, and/or by virtue of a transaction amount, and/or by virtue of nature of goods or combination of goods sought to be purchased. The message may be a voice or text message and the code may be input using voice or text entry on the telephone.

In another aspect, a credit card transaction approval system includes means for receiving, from a vendor, a transaction request for a purchase of goods and/or services using a credit hard, and means for determining whether a transaction represented by the transaction request is suspect. The system also includes means for, in the event of a suspect transaction, sending a telephone message to a telephone associated with a holder of the credit card to input a predetermined code indicating authorization by the holder of the transaction. Means are provided for denying the transaction if a code input by means of the telephone does not match the predetermined code.

In still another aspect, a credit card transaction approval system includes a credit card authorization computer receiving transaction requests from vendors. Prior to rejecting a suspect transaction in response to a transaction request, the computer transmits, to a telephone associated with a holder of a credit card sought to be used in the transaction, a message requesting an authorization code.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with present principles; and

FIG. 2 is a non-limiting flow chart of the present logic.

### DETAILED DESCRIPTION OF THE PREFERRED EMBODIMENT

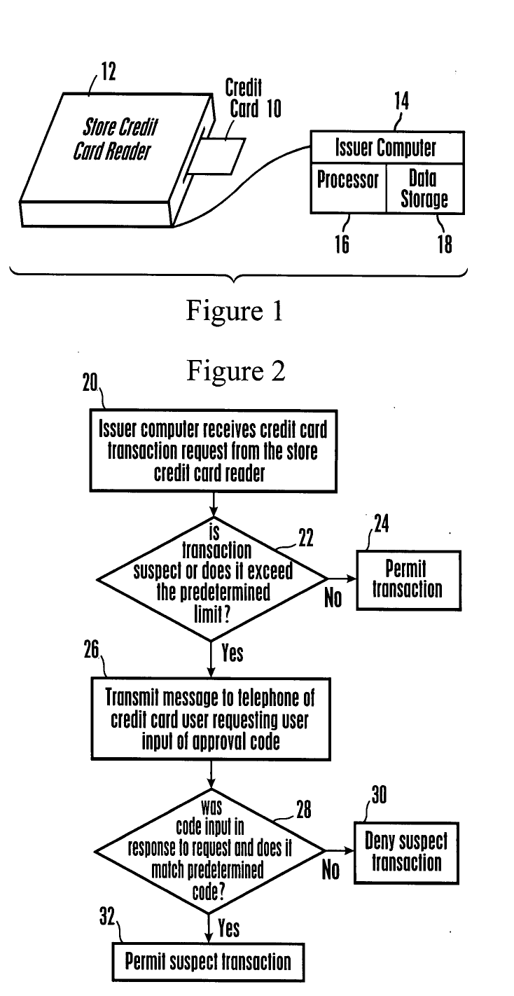

Beginning with FIG. 1, the arrangement for a store credit card reader that is electronically linked to an issuer computer is shown. The credit card 10 is shown being inserted into the store credit card reader 12. When the credit card holder is purchasing an item(s) from a vendor, this is the typical fashion for charging the agreed upon amount to the credit card holder's credit card. An alternative method not shown in the present diagram, but presumed to be included under the scope of the present invention, is for the sales clerk to manually enter the credit card number shown on the face of the card into the store credit card reader using a numerical keypad, instead of physically inserting the credit card 10 into the reader 12. The method of entry shown enters the credit card number automatically when a magnetic strip embodied on the credit card, which is encoded with the credit card number, is inserted and read by the credit card reader 12.

The store credit card reader 12 is electronically connected to a credit card authorization computer 14, which receives the credit card transaction request from the store credit card reader 12. The computer 14 includes at least one processor 16 and data storage 18. Typically, the computer 14 is operated and maintained by the bank or credit agency that issued the credit card to the credit card holder.

Moving to FIG. 2, the logic illustrating the method of permitting credit card transactions is shown. Commencing the logic at block 20, the issuer computer receives the credit card transaction request from the store credit card reader 12. At decision diamond 22, the logic determines whether the requested transaction is suspect for a reason determined by the bank or agency that issued the credit card to the credit card holder, including exceeding of the predetermined credit limit. Other non-limiting heuristics for determining whether a transaction is suspect include whether the location of the attempted transaction is beyond the card holder's normal geographic area for purchases, an unusually large transaction amount, and the nature of goods or combination of goods sought to be purchased. In any case, if the logic determines that the transaction is not suspect, the logic permits the transaction at block 24.

However, if the logic determines that the transaction is suspect, the logic progresses to block 26 where a message is transmitted to the telephone of the credit card holder. The message may be a voice message or a text message or other type of telephone-appropriate message. It is to be understood that the card holder provides the credit card issuer with the number of, e.g., the card holder's mobile telephone.

The message may summarize the attempted transaction, e.g., the message may give the location and amount of the transaction and, in some implementations, the nature of goods sought to be purchased.

Regardless of whether the message summarizes the transaction, the message requests that the card holder input the predetermined approval code so that the transaction may be permitted. Code input may be by text input using the telephone or by voice, in which case the computer 14 possesses voice recognition capability. The code may be determined by either the credit card issuer or the credit card holder but in any case is agreed to in advance by both the issuer and holder.

Moving to decision diamond 28, the logic determines whether a code has been input by the credit card holder in response to the request made at block 26 and, if the code has been input, the logic also determines whether that code matches the predetermined code. If the code was not input by the credit card holder (typically within a predetermined period, e.g., one minute) or if the code fails to match the predetermined code, the logic concludes at block 30 where the suspect transaction is denied. Should the code input by the credit card holder match the predetermined code, the logic instead concludes at block 32, where the suspect transaction is permitted, which avoids an inconvenient and/or embarrassing moment on the part of the credit card holder.

While the particular SYSTEM AND METHOD FOR PERMITTING OTHERWISE SUSPECT CREDIT CARD TRANSACTIONS is herein shown and described in detail, it is to be understood that the subject matter which is encompassed by the present invention is limited only by the claims.

What is claimed is:

1. A method for permitting credit card transactions, comprising:
receiving a credit card transaction request;
if the transaction request is suspect, transmitting to a telephone of a card holder of the credit card a message to input a code to indicate approval of the transaction;
if the code is input, determining if it matches a predetermined code;
if the code is not input or if it is input but fails to match the predetermined code, denying the transaction, and otherwise permitting the transaction.

2. The method of claim 1, wherein the transaction is suspect by virtue of exceeding a predetermined credit limit.

3. The method of claim 1, wherein the transaction is suspect by virtue of a location of an attempted transaction.

4. The method of claim 1, wherein the transaction is suspect by virtue of a transaction amount.

5. The method of claim 1, wherein the transaction is suspect by virtue of nature of goods or combination of goods sought to be purchased.

6. The method of claim 1, wherein the message is a voice message.

7. The method of claim 1, wherein the message is a text message.

8. The method of claim 1, wherein the code is input by voice.

9. The method of claim 1, wherein the code is input by text entry on the telephone.

10. A credit card transaction approval system, comprising:
means for receiving, from a vendor, a transaction request for a purchase of goods and/or services using a credit hard;
means for determining whether a transaction represented by the transaction request is suspect;
means for, in the event of a suspect transaction, sending a telephone message to a telephone associated with a holder of the credit card to input a predetermined code indicating authorization by the holder of the transaction; and
means for denying the transaction if a code input by means of the telephone does not match the predetermined code.

11. A credit card transaction approval system, comprising:
a credit card authorization computer receiving transaction requests from at least one vendor, wherein
prior to rejecting a suspect transaction in response to a transaction request, the computer transmits, to a telephone associated with a holder of a credit card sought to be used in the transaction, a message at least in part requesting an authorization code.

12. The system of claim 11, wherein the message includes a summary of the transaction.

13. The system of claim 11, wherein the transaction is permitted by the computer only if a code matching a predetermined code is input using the telephone within a predetermined time period.

14. The system of claim 11, wherein the transaction is suspect by virtue of exceeding a predetermined credit limit.

15. The system of claim 11, wherein the transaction is suspect by virtue of a location of an attempted transaction and/or by virtue of a transaction amount and/or by virtue of nature of goods or combination of goods sought to be purchased.

16. The system of claim 11, wherein the message is a voice message.

17. The system of claim 11, wherein the message is a text message.

18. The system of claim 11, wherein the code is input by voice.

19. The system of claim 11, wherein the code is input by text entry on the telephone.
